(19) United States
(12) Patent Application Publication
(10) Pub. No.: US 2026/0054370 A1
(43) Pub. Date: Feb. 26, 2026

(54) EXOSKELETON INCLUDING MONITORING AND MAINTENANCE TOOLS

(71) Applicant: IUVO S.R.L, Pontedera (PI) (IT)

(72) Inventors: Francesca DE SIMIO, Pontedera (PI) (IT); Giulia BIGONI, Pontedera (PI) (IT); Matteo BIANCHI, Pontedera (PI) (IT); Matteo MOISE, Pontedera (PI) (IT); Luca MORELLI, Pontedera (PI) (IT); Francesco GIOVACCHINI, Pontedera (PI) (IT); Nicola VITIELLO, Pontedera (PI) (IT)

(21) Appl. No.: 19/103,638

(22) PCT Filed: Aug. 31, 2023
(86) PCT No.: PCT/IB2023/058629

§ 371 Date: Feb. 13, 2025

Related U.S. Application Data
(60) Provisional application No. 63/403,489, filed on Sep. 2, 2022.

(51) Int. Cl. B25J 9/00; B25J 9/16

(52) U.S. Cl. CPC B25J 9/0006; B25J 9/1674

(57) ABSTRACT

An exoskeleton device includes components and/or systems for monitoring or regulating the performance of the exoskeleton. The components and systems include an integrated Internet of Thing (IoT) module that enables exoskeletons, either individually or collectively in a fleet, to provide users, operators, technicians, etc., with a cloud-based monitoring and maintenance management tool for observing data obtained from the IoT module of the exoskeleton and a fleet of such exoskeletons.

### FIELD OF ART

The system relates to passive, portable, and assistive exoskeletons arranged to reduce the physical effort of users and onboard componentry for monitoring or regulating the performance of the exoskeleton, along with modules for managing, storing, and visualizing data obtained from the onboard componentry.

### BACKGROUND

Wearable industrial exoskeleton technologies can improve endurance and safety in industrial settings. These exoskeletons prevent common workplace injuries by minimizing muscle and tendon overuse and could increase industrial productivity. To reduce employee fatigue and workplace injuries, exoskeletons can support and augment an operator during strenuous activities, including lifting, stooping, bending, squatting, and overhead work. Exoskeletons may be additionally valuable in repetitive and awkward activities. An exoskeleton allows operators to hold heavy hand tools, increasing productivity and accuracy by reducing muscle fatigue. Through an exoskeleton system, older workers with valuable experience and intuition may be able to work longer than they otherwise could in physically demanding or challenging jobs.

An exoskeleton system may be arranged to transfer loads through the exoskeleton to the ground in standing or kneeling positions, allowing operators to use heavy tools as if they were weightless. Therefore, exoskeletons can reduce physical stress during strenuous tasks involving repetitive shoulder flexion movements. The exoskeleton system can be configured to move naturally and adapt to different body types and heights. The exoskeleton system can replicate the shoulder's dynamic movement while the interface can enwrap the operator's body like a second skin.

An exemplary exoskeleton system is arranged for the upper body, including the shoulder and arms, by enhancing performance by reducing forces at the shoulder (e.g., gravitational forces that urge the arms downward) and enabling the operator to perform chest-to-ceiling level tasks for extended periods, with less effort. The exoskeleton may help the operator elevate and support the arms and reduce physical risks and discomfort from tasks carried out above chest height or overhead.

It has been found that the lower body, trunk, and upper body regions could benefit from active and passive exoskeletons. Muscle-activity reductions have been reported as an effect of active and passive exoskeletons. Exoskeletons can potentially reduce the underlying factors associated with work-related musculoskeletal injury. While certain exoskeletons are available, several technical issues hinder the practical use of exoskeletons in the industry. Specific problems include discomfort for passive and active exoskeletons, the device's weight, alignment with human anatomy and kinematics, and detection of human intention to enable smooth movement for active exoskeletons.

Another issue is ensuring that the exoskeleton system's assistance is commensurate with the operator's particular needs and activities. Existing systems may provide static or dynamic assistive forces but require complex control and adjustment systems, making adapting exoskeleton systems to different operators in subsequent shifts costly and impractical. Still, existing exoskeleton systems are insufficiently adaptable to the operators'specific dimensions, strengths, and tasks, leading to poor compliance and poor results across different operators. Existing exoskeletons may be poorly adapted to allow an operator to perform unrelated tasks and be doffed if such tasks are to be comfortably and effectively performed.

Examples of passive (without motors), assistive, and portable exoskeletons are found in WO 2022/043862A1, published on Mar. 3, 2022, and WO 2022/079610A1, published on Apr. 21, 2022, both incorporated by reference. These exoskeletons aim to provide consistent, ergonomic support for the shoulders and upper body to ease muscle fatigue and facilitate movement for overhead and repetitive tasks. The passive and portable exoskeletons are arranged to assist the user's upper limbs in flexion-extension movements when lifting or manipulating objects. It is a garment made generally of three parts: the back, waist, and arm.

The exoskeleton includes a mechanical shoulder chain to guarantee protection from external outdoor conditions like water, dirt, heat, and UV light. The back of the exoskeleton now features a frame structure that better supports ergonomic posture. It has been estimated that such an exoskeleton can help workers increase accuracy during overhead tasks by 27% and execution speed by 10%; it can also reduce cycle times by at least five percent.

Safety concerns further limit the widespread adoption and use of assistive exoskeleton systems. As exoskeleton systems can support the extension and flexion of an operator's joints, an operator can be injured through over-extension or over-flexion of joints due to the assistive forces provided by these systems. Similar concerns exist regarding damage to the exoskeleton systems or non-operators, as tension stored in exoskeleton systems may be released suddenly when not in use, causing damage to the exoskeleton systems and their surroundings, which can be expensive to mitigate or repair. Therefore, a need exists for safer and more straightforward operating and monitoring exoskeleton systems.

As there may be multiple exoskeletons assigned to a team of workers, it has been previously challenging to assess the individual performance of the user and the exoskeleton, and a determination as to the efficacy of the exoskeleton, in addition to the tracking and monitoring of the exoskeleton, among a fleet of exoskeletons. Moreover, as the exoskeletons are provided in working conditions that may be considered harsh (i.e., through the climate, environment, activities, etc.), it would be helpful to understand the physical condition of the exoskeleton.

This disclosure's embodiments aim to overcome these technical issues and provide exoskeleton solutions with an improved exoskeleton system that can overcome existing problems and lead to broader adoption by different industries. Such solutions involve an exoskeleton fleet's cloud-based monitoring and maintenance management tool.

### SUMMARY

Embodiments of the disclosure system relate to a passive or pseudo-passive exoskeleton system for relieving a load on a joint, such as a shoulder, and assisting an operator's effort. The embodiments of the present disclosure improve the prior art solutions discussed above, particularly by offering a cloud-based monitoring and maintenance management tool for an exoskeleton fleet. The embodiments offer a monitoring and management system of existing and future exoskeletons. In the case of an existing exoskeleton, the exoskeleton can be retrofitted with minimal or no impact on the operation and structure of an existing exoskeleton.

Embodiments include exoskeleton technology, such as shoulder exoskeletons, along with an integrated Internet of Thing (IoT) module that enables all the exoskeletons, either individually or collectively in a fleet, to provide users, operators, technicians, etc., with a cloud-based monitoring and maintenance management tool for observing data obtained from the IoT module of the exoskeleton and a fleet of such exoskeletons.

The IoT module can be embedded in different exoskeletons with different features. One or more IoT modules can be applied at different locations on or along the exoskeleton. The IoT module can be configured in various configurations, including as a stand-alone device, a device connected to other sensors placed in different parts of the exoskeleton, and sensors not placed on the exoskeleton.

The cloud-based monitoring and maintenance management tool can provide, throughout the lifecycle of each exoskeleton, information on its daily use, diagnostic and fault prevention, data visualization on the usage of the fleet, and standard interoperability to an application programming interface (API) to allow integration with enterprise resource planning (ERP), and other business management software, as well as business intelligence systems.

The IoT-enabled exoskeleton is arranged to provide feedback to the end user via an output device (LEDs or display) to indicate faults, the need for preventive maintenance, or to provide notifications based on the device's use (usage hints). The IoT module can also be arranged to provide information to the user (as a communication module).

According to the cloud-based monitoring and maintenance management tool, an exoskeleton can be retrofitted to house a dedicated sensor assembly, such as in housing supporting components of the exoskeleton, to enable the device to collect, process, and visualize.

The sensor assembly may include an onboard, battery-powered microcontroller-based board to collect data and upload it to a data aggregation and lifecycle management cloud software platform, a data aggregation and lifecycle management cloud software platform, and a data processing and visualization cloud software platform. The sensor assembly may be configured to measure several movement cycles of the exoskeleton (corresponding to a predetermined location and component), and additional metrics on the cycles (e.g., movement range, movement speed, etc.), an approximate location of the exoskeleton (such as through GPS technology).

The cloud-based monitoring and maintenance management tool may be configured in at least two modes for uploading data: “quasi-real-time,” with data to be uploaded every fixed minute (possibility to set different options), which mode may be used whenever possible, and “differed,” with data to be uploaded as soon as connectivity resumes, typically at the end of each day, with the potential for storing data locally for longer periods.

The data aggregation and lifecycle management platform is arranged for the remote configuration of the boards, is configured to collect and aggregate data, and its functionality via REST Web APIs.

The data processing and visualization platform is arranged as the point of entry for the customer, providing a collection of data exploration and visualization tools to monitor their exoskeleton fleet. The data aggregation platform can communicate with each board to signal a malfunction or the need for preventive/urgent maintenance and provide useful hints for better operability.

In managing and controlling the fleet, the platform is arranged to control devices onboarding and provisioning with sufficient security; the lifecycle of devices with remote procedure call and Over-the-air updates (FOTA) through REST APIs; control data Management for storage, aggregation, and feeding of data to data visualization platform; event management with integrated alarm engine; dedicated data storage service, analytics, and dashboarding; and data files available to download.

A dashboard may be provided for observing data obtained from the monitoring and maintenance management tool. Custom login and personalized dashboards may be offered, and such dashboards may be public or private.

According to embodiments of the disclosure, a passive exoskeleton for the upper limbs is provided that can monitor the motion of the arm or other biomechanical motions of the user. The passive exoskeleton is provided with a sensor system that at least can count the number of cycles completed by the device and is arranged to communicate the data with a central system that can provide alerts when maintenance should be performed. The passive exoskeleton can receive information from a central system. It can provide this information to the user, an operator, a technician, or any other individual monitoring the status and performance of the exoskeleton.

Unlike in known exoskeletons, the cloud-based monitoring and maintenance management tool having the IoT module and sensor system may be provided in a kit adapted to be secured and operated out of either an existing or retrofitted casing or a casing unique to the IoT module and sensory in components of an existing passive upper limb exoskeleton for workers. Advantageously, the existing exoskeleton may be used, which avoids redesign and enables known exoskeleton components to be augmented by the sensor system by adding the benefit of performance monitoring and status.

Advantageously, the solutions of the disclosure offer miniaturization and integration of the IoT module and the sensor system into a single component of the pre-existing device. Therefore, the solutions are adapted to an existing and effective commercial solution by inserting into or minimally adapting the casing. Yet further advantageously, no cables/wires extend from the casing concerning the individual IoT module and sensor system such that they are fully contained, thereby without any component of the sensor system located external to the case, and thereby eliminating the possibility of damage from extending wires or possible injury to the user and exoskeleton. No backpack or additional boards are present in different parts of the exoskeleton. Indeed, there is no need for additional external components on the exoskeleton, enabling free movement for the user with minimal weight gain.

Examples of the data obtained by the sensor system include time spent in one or more pre-defined positions, the total number of flexion/extension cycles, the frequency of the movement (e.g., flexion/extension cycles/min), and angular excursions, although the list is non-restrictive. From the data above, the following can be derived as indicators of online or offline calculation of ergonomic indexes related to the work performed (in conjunction with the knowledge of other possible parameters needed for the calculation of the index), the quality of the movement and quality of the work performed, level of fatigue of the user, quality of the wearing, and safety aspects.

These and other features, aspects, and advantages of the present disclosure will better understand the following description, appended claims, and accompanying drawings.

### BRIEF DESCRIPTION OF THE DRAWINGS

FIG. 1 is a perspective view mainly directed to a posterior aspect of an exoskeleton system, including a monitoring system according to the disclosure.

FIG. 2 is an elevational view direction to an anterior aspect of the exoskeleton in FIG. 1.

FIG. 3 is a detailed perspective view of the exoskeleton of FIG. 1.

FIG. 4 is a detailed view IV taken from FIG. 2 illustrating a control panel associated with the monitoring system of FIG. 3.

FIG. 5 is an exemplary view illustrating a monitoring system including an IoT module embedded in the casing of an assistive device of FIG. 1.

FIG. 6 is an exemplary view illustrating the circuitry and communication interface for a custom IoT-enabling multi-sensor board.

FIG. 7 is a diagram illustrating a cloud-based monitoring and maintenance system, including the exoskeleton of FIG. 1.

FIG. 8 is an exemplary view illustrating a diagram of components of the IoT enabling multi-sensor board.

FIG. 9 shows exemplary views of a device manager screen forming part of the monitoring and maintenance system.

The drawing figures are not necessarily drawn to scale. Instead, they are drawn to provide a better understanding of the components and are not intended to be limiting in scope but to provide exemplary illustrations.

### DETAILED DESCRIPTION OF VARIOUS EMBODIMENTS

### A. Overview

A better understanding of different embodiments of the disclosure may be had from the following description read with the accompanying drawings in which like reference characters refer to like elements. While the disclosure is susceptible to various modifications and alternative constructions, certain illustrative embodiments are in the drawings and are described below. It should be understood, however, that there is no intention to limit the disclosure to the embodiments disclosed; on the contrary, the intention covers all modifications, alternative constructions, combinations, and equivalents falling within the spirit and scope of the disclosure.

A better understanding of different embodiments of the disclosure may be had from the following description read with the accompanying drawings in which reference characters refer to like elements.

It will be understood that unless a term is defined to possess a described meaning, there is no intent to limit the meaning of such term, either expressly or indirectly, beyond its plain or ordinary meaning.

### B. Definitions

For ease of understanding, the disclosed embodiments of an exoskeleton and components for use therewith, the interior and exterior portions of the exoskeleton, may be described independently. The interior and exterior portions of the exoskeleton function together to support a user in exerting efforts.

A description of a few terms, when used, is necessary for further ease of understanding the embodiments of an orthopedic device as disclosed. As used, the term “proximal” has its ordinary meaning and refers to a location next to or near the point of attachment or origin or a central point located toward the center of the body. Likewise, the term “distal” has its ordinary meaning and refers to a location situated away from the point of attachment or origin, a central point, or located away from the center of the body.

Medial is toward the midline of the body or the median or mid-sagittal plane, which splits the body, head-to-toe, into two halves, the left and right. Lateral is the side or part of the body away from the middle. In the knee, the medial side is on the inside of the exoskeleton, and the lateral side is on the outside of the device relative to the median plane.

The term “posterior” also has its ordinary meaning and refers to a location behind or at another location's rear. The term “anterior” has its ordinary meaning and refers to a location ahead of or in front of another location.

The term “frontal plane” has its ordinary meaning and refers to a plane extending through a body to divide the body into the front or anterior and back or posterior halves. The term “sagittal plane” has its ordinary meaning and refers to a plane extending through a body to divide the body into left and right halves, as in the mid-sagittal plane referenced above. The term “transverse plane” has its ordinary meaning and refers to a plane extending through a body to divide it into the top, upper, bottom, or lower halves.

An Internet of Things (IoT) describes the network of physical objects—“things”—embedded with sensors, software, and other technologies to connect and exchange data with other devices and systems over the Internet.

### C. Various Embodiments of the Exoskeleton and Components for Use Therewith

The exoskeleton and components for use therewith, according to embodiments of the present disclosure, advantageously overcome the problem of exoskeletons and other devices being vulnerable to contamination and therefore needing costly repairs and replacements by providing improved components that shield an interior of the exoskeleton, including components housed in the interior of the exoskeleton, from contaminants.

Protective components may be provided to extend at or through a junction between components defining the body of a component, such as one or more assistive devices. Protective components may be formed from elastomers or other polymeric materials as suitable. They may be custom-fitted to the unique profiles and shapes of the exoskeleton components.

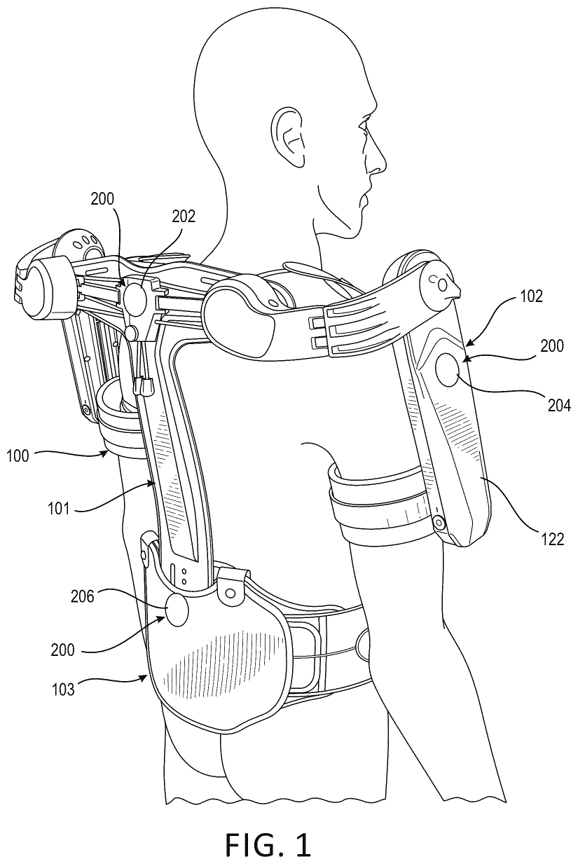

FIG. 1 illustrates an exoskeleton 100 according to at least according to WO 2022/043862A1, and WO 2022/079610A1, and adapted to accommodate a sensor system or IoT module of a cloud-based monitoring and maintenance management tool 200 for tracking and transforming performance characteristics of the exoskeleton. The exoskeleton 100 includes a frame system 101 attached to a lumbar assembly 103, and supporting assistive systems. As exemplified by FIG. 1, at least one IoT module, specifically three IoT modules, 202, 204, and 206, are located at various predetermined locations on the exoskeleton. The IoT modules may obtain different information and data corresponding to the predetermined location. They may communicate with one another to offer data dependent upon one another, all being selected by the user, operator, or manager for detecting and measuring the performance of the exoskeleton.

A sensor system is connected to the assistive device, such as a torque-generating box 122, and the assistive device communicates with the IoT module 202. Of course, as shown in FIG. 1, IoT modules 202, 204, and 206 may be located at different locations along the exoskeleton, and an appropriate sensor system may be provided in addition to that according to the movement obtained at such locations or other desired data. Such an arrangement can be adapted to different wearable devices besides the depicted exoskeleton and located accordingly.

In the sensor system and corresponding IoT module, the onboard electronics are embedded in the torque-generating box arranged for moving with a user's arm. If used for sensing the movement, the sensor system may include a movement sensor, and it could be placed in or connected to any moving parts of an exoskeleton.

As the sensor system and IoT module are embedded into the casing of the torque-generating box, the exoskeleton includes no external wires. However, the exoskeleton is not limited to having exposed wires, as it may be envisioned to connect different sensor systems and IoT modules over the exoskeleton, although such communication may also be configured wirelessly. Nonetheless, according to each IoT module and sensor system at a specific location, such as at the torque generating box, they should be completely encased in the casing and/or other suitable housing according to different locations.

As discussed, the IoT module can be a stand-alone device, or it can be connected to other sensor systems; aside from the sensor system, it is in direct communication or the sensor system it is associated with in a casing and a predetermined active component of the exoskeleton (i.e., torque generating box). Likewise, the IoT module may be in communication with sensor systems located outside of the exoskeleton.

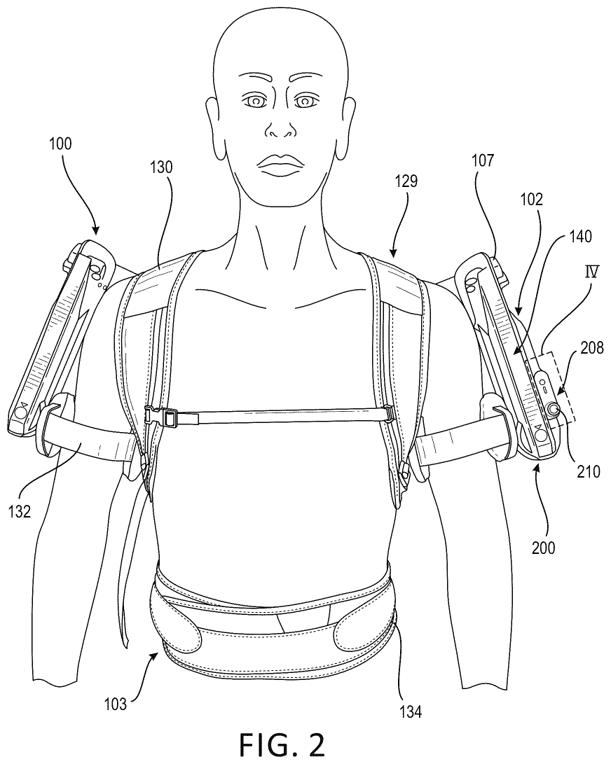

FIG. 2 illustrates the strapping system 129 of the exoskeleton 100, combined with the IoT modules or sensor system 200. The strapping system 129 includes shoulder straps 130, base arm supports 132, and a waist belt 134. The IoT module 200 is provided on the assistive device 107 and incorporated with the housing thereof to offer an interface 208, enabling the user or operator to actuate features of the IoT. Such features may include on/off switch 210, a USB hub for data download or upload or battery charger connection, and lights indicating certain degrees of performance.

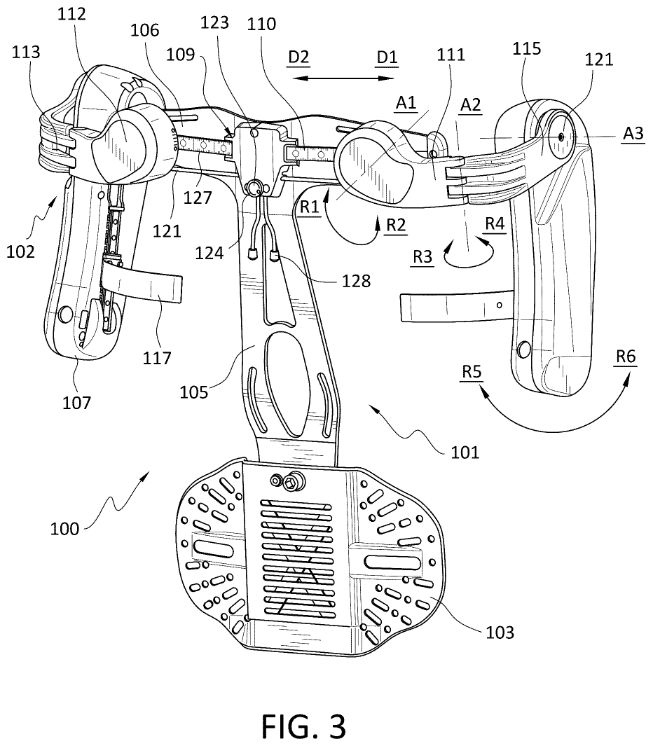

FIG. 3 shows in perspective view an exoskeleton 100 according to the embodiments. The exoskeleton 100 includes the frame or a frame system 101, and the assistive system 102 comprises one or more assistive devices 107. Each of the assistive devices 107 may correspond to an arm of a user and attach to it by an arm cuff 117. The frame system 101 may comprise a vertical strut 105 extending proximate to a user's back and attaching to the user at a lumbar assembly 103, as described in at least U.S. Patent Application Publication No. 2018/0303699, published on Oct. 25, 2018, U.S. patent application Ser. No. 16/750,352, filed Jan. 23, 2020, and U.S. Design Patent No. 876,654, granted Feb. 25, 2020, each document being incorporated herein by reference.

The frame system 101 may comprise a width adjustment feature 109, allowing the assistive devices 107 to correspond to the width of a user's shoulders. The width adjustment feature 109 may include a slider truck 110 extending horizontally along a horizontally extending strut 106 of the frame system 101 and allowing the assistive device 107 to be translated in directions D1, and D2. The width adjustment feature 109 may include one or more tensioning elements 121, allowing users to adjust the width of the assistive devices 107. For example, a user may apply increased tension to the one or more tensioning elements 121 to draw the assistive devices 107 in a medial direction D2 or release a degree of tension to allow the one or more assistive devices 107 to translate in a lateral direction D1, as suitable.

One or more tensioning elements 121 may be formed from any suitable material. In embodiments, one or more tensioning elements 121 are formed from an elastomeric material, such as natural or synthetic rubbers, silicone, EPDM, nitrile, neoprene, ethylene propylene diene monomer (EPDM), combinations thereof, and any other suitable material. One or more tensioning elements 121 may correspond to an assistive device 107 and be provided in substantially symmetric configurations relative to each other for ease and simplicity of use.

An adjustment mechanism 123 provides the desired degree of tension to one or more tensioning elements 121. The adjustment mechanism 123 may apply tension to one or more tensioning elements 121, as described in U.S. patent application Ser. No. 16/750,352, filed Jan. 23, 2020, and incorporated herein in its entirety by reference. The adjustment mechanism 123 may comprise a body through which channels are defined and configured for receiving one or more tensioning elements 121 into the body. The adjustment mechanism 123 may define a dial 124 arranged for turning in a tensioning direction (in which one or more of the tensioning elements 121 may be tensioned) or in a release direction (in which the tension may be reduced in one or more tensioning elements 121).

In embodiments, the adjustment mechanism 123 does not utilize a spring or resilient element to apply tension to one or more tensioning elements 121 or wind the tensioning elements 121 as in a dial-tensioning mechanism. In embodiments, the dial 124 may comprise a screw extending into the body of the adjustment mechanism 123 to clamp or retain the tensioning elements 121 and prevent movement of the tensioning elements.

A terminal end 128 of the tensioning elements 121 may be pulled to adjust the width of the assistive devices 107 when the dial 124 is loose to move the first hinge mechanism 112 in a medial direction D2. The terminal end 128 may slide outwardly in a lateral direction D1 under the natural bias of the assistive devices 107 as desired. In embodiments, one or more tensioning elements 121 may be substantially inelastic. The terminal end 128 of the one or more tensioning elements 121 may drop down from the width adjustment feature 109 as another indicia of the width of the assistive devices 107 and for convenient manipulation of the terminal ends 128.

The slider truck 110 may define indicia 127 that indicate to a user tension in the one or more tensioning elements 121 and width of the assistive devices for intuitive and accurate adjustment of the one or more tensioning elements such that the first hinge mechanism 112 aligns substantially incident with a user's shoulder. Such features may be important for off-the-shelf production and use of an exoskeleton according to the embodiments of the disclosure and/or in environments where shift workers alternate use of an exoskeleton. Users on a subsequent shift can easily adjust the width of the exoskeleton and associated components based on their dimensions.

While a single adjustment mechanism 123 is shown and described, it will be appreciated that the depicted embodiment is merely exemplary. Multiple parallel adjustment mechanisms 123, each corresponding to a respective tensioning element, may be used as deemed suitable.

One or more hinge components 112, 113, and 125 may be provided to allow the assistive devices 107 to assist a user in exerting efforts in a plurality of arm and shoulder positions. Each of the one or more hinge components 112, 113, and 125 may correspond to an axis of rotation and shoulder motion. The axes of rotation may be substantially orthogonal to one another. For example, a first axis A1, about which the first hinge component 112 is configured to rotate in directions R1, and R2 may facilitate abduction and adduction. The first axis, Al may extend horizontally through an anterior/posterior plane.

A second axis A2 may extend vertically through the second hinge 113 and facilitate horizontal rotation in directions R3, and R4 to facilitate internal and external rotation of the shoulder. A third axis, A3 may extend horizontally through the third hinge 125 in directions R5 and R6 to facilitate the shoulder's extension and flexion (i.e., upward and downward movement). By providing three hinges 112, 113, and 125 corresponding to axes A1, A2, and A3 substantially orthogonal to each other, the assistive devices 107 may be configured to assist a user in exerting effort in a plurality of suitable positions and configurations.

A detailed discussion of the assistive devices 107 is found in WO 2022/079610A1. A casing 140 is provided, which encases the components of the assistive devices. An advantage of the proposed solution of providing connectivity and data acquisition of the performance and operating status of the exoskeleton is that the IoT module and the sensor system may be adapted to existing casing components, or such casing components may be minimally adapted to accommodate the IoT module and sensor system.

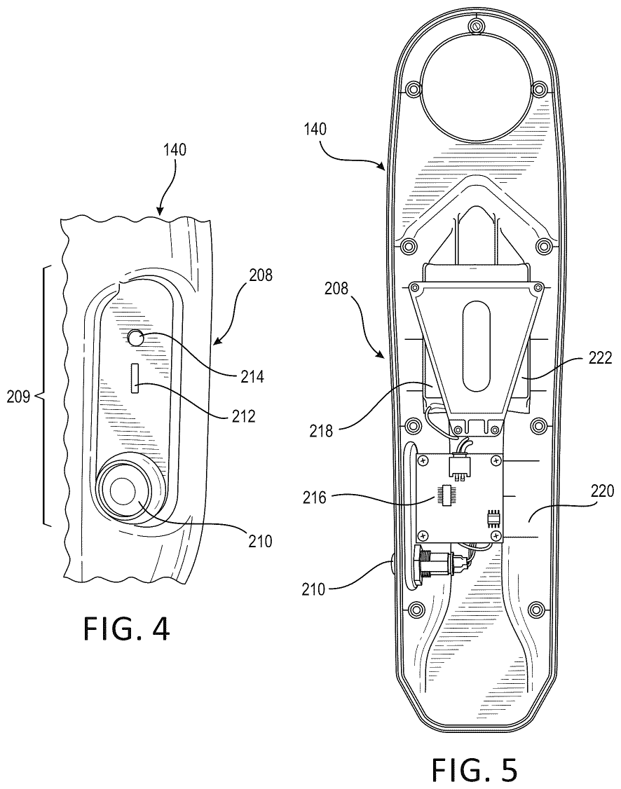

FIGS. 2, 4, and 5 show the casing 140 adapted to accommodate the IoT module and sensor system or simply the circuitry thereof of the cloud-based monitoring and maintenance management tool. For example, FIG. 4 shows how casing 140 is adapted with an external interface 209 to the IoT module. The external interface 209 includes an on/off or reset actuator 210 accessible exteriors of the casing 140 for operation. A data port or connectivity (e.g., to a battery) 212 of any appropriate type enables an operator to communicate with the circuitry. An activation signal 214 is likewise provided to notify the user and operator of whether the circuitry is in use.

FIG. 5 exemplifies how the circuitry 216 and a corresponding battery 218 may be embedded in the casing 140. A suitable recess 220 and retainer 222 permit secure placement and retention by the casing 140. The casing 140, however, despite the embedded circuitry, can maintain its profile originally designed for the exoskeleton before adapting the IoT module and sensor system. Such ability is advantageous because existing commercial exoskeletons can be used and adapted accordingly to include the enhancements discussed in this disclosure and permit full compatibility with existing devices.

While the communication and sensor system has been generally discussed as the IoT module and the sensor system, the following discussion offers insight into more specific modules according to the communication and sensor system. Generally, the solution provides the following platforms: (1) an onboard, battery-powered microcontroller-based board to collect data and upload it to a data aggregation and lifecycle management cloud software platform; (2) a data aggregation and lifecycle management cloud software platform; (3) data processing and visualization cloud software platform. Platforms 2 and 3 will be either self-hosted by the customer or hosted on a private cloud solution. These platforms enable the measurement of the exoskeleton in movement or the number of corresponding cycles and additional metrics on the cycles, including movement range, movement speed, and other associated movement data.

The onboard components can be retrofitted to exoskeleton designs. In addition to the aforementioned measurement capabilities, the onboard components can include a GPS module to track the location of the exoskeleton. The onboard components can be arranged in a quasi-real-time tracking mode, with data to be uploaded in predetermined periods (i.e., every fixed minute) and the possibility to set different options. Likewise, tracking can be arranged in a different tracking mode, with data to be uploaded as soon as connectivity resumes, typically at the end of each day, with the potential for storing data locally for longer periods (e.g., one week).

The data aggregation and lifecycle management platform will allow the remote configuration of the boards, collect and aggregate data, and provide all of its functionality via REST Web APIs. The data processing and visualization platform is arranged to be the point of entry for the customer, providing a collection of data exploration and visualization tools to monitor their exoskeleton fleet. The data aggregation platform is arranged to communicate with each board to signal a malfunction or the need for preventive/urgent maintenance or provide optional usage hints, similar to fitness trackers.

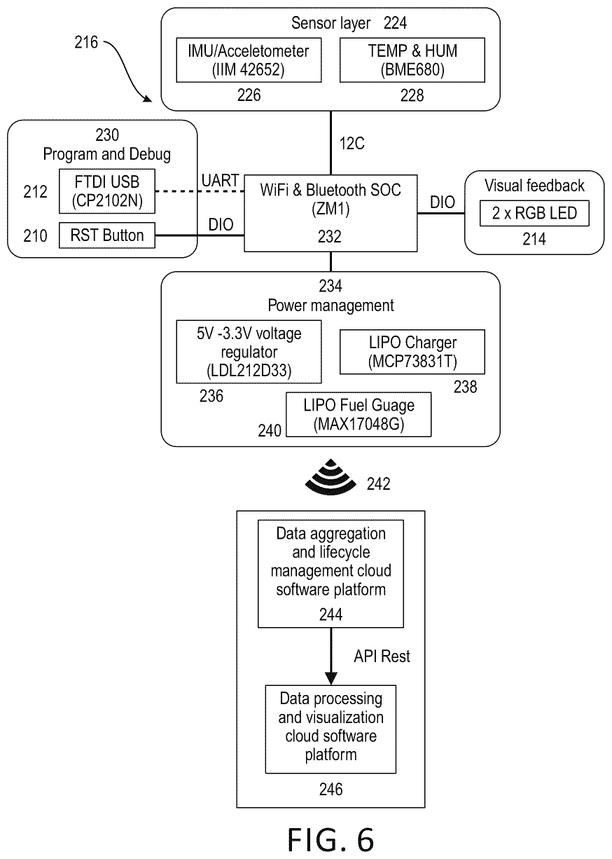

FIG. 6 is a schematic view of a custom IoT enabling multi-sensor board 216 comprising the onboard componentry. The board is an onboard, battery-powered microcontroller-based to collect and upload data to a data aggregation and lifecycle management cloud software platform.

The board includes a sensor layer 224 having an IMU/accelerometer 226 and a temperature and humidity sensor 228. A program and debug component includes the reset or on/off actuator 210 and the data or battery connectivity port 212, which may be a USB hub. The activation signal 214 with at least one LED light offering visual feedback. These components are connected centrally to a WiFi and Bluetooth System on Chip (SoC) or IoT module 232 (e.g., ESP32-WROOM). The IoT module 232 is connected to a power management module 234, including the LiPo battery 218, a voltage regulator 236, a LiPo charger 238, and a fuel gauge 240.

The IoT module 232 communicates wirelessly to a data aggregation and lifecycle management cloud software platform 244. The platform 244, in turn, communicates with an application programming interface (API) of a REST type to a data processing and visualization cloud software platform 246.

The IoT enabling multi-sensor board 216 provides an assortment of benefits, including lower power consumption, enabling the measurement of repeated cycles of use of the exoskeleton. The board 216 offers reduced dimensions without interfering with the measured components of the exoskeleton (e.g., torque generating box). With the external interface 209, a user or operator is provided easy-to-plug connectors to the board 216. The board 216 may be provided with a crypto chip to enhance security. The sensor system includes industrial-grade motion and environmental parameter sensors to withstand operating conditions and the exoskeleton's environment. Further, the WiFi and Bluetooth connectivity maximize compatibility with professional and consumer equipment without the necessity of exterior wires extending from the casing of the exoskeleton.

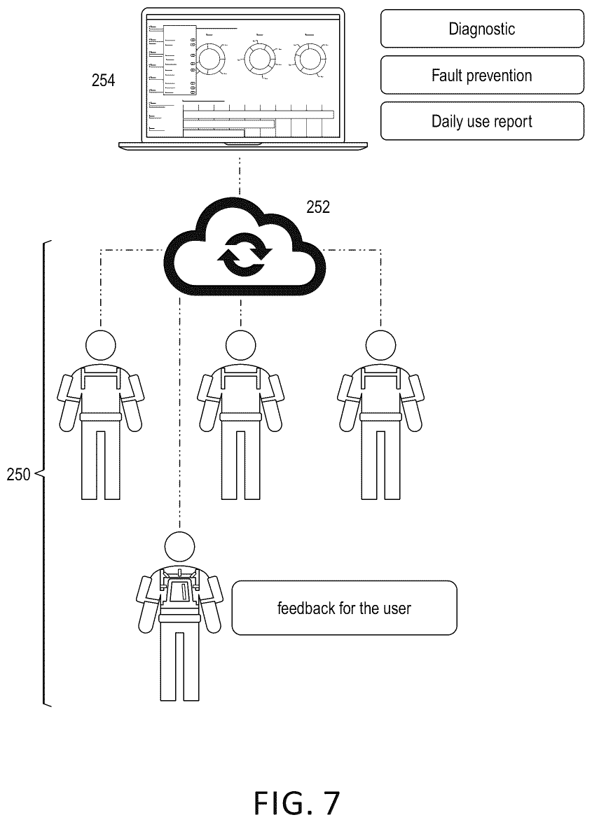

Referring to FIG. 7, a fleet of exoskeletons 250 can be managed by the onboard componentry and corresponding modules with cloud-based transmissions 252. The information is sent to an operator via modules 254, enabling diagnostics, fault prevention, data visualization on the usage of the fleet, and daily use reports. The data can be used for standard interoperability API to allow integration with the ERP (enterprise resource planning) and other business management software and business intelligence.

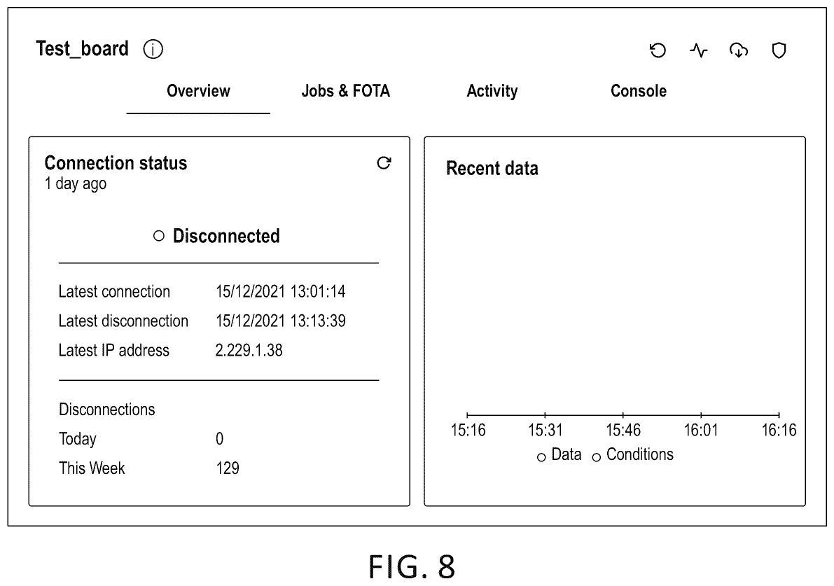

As exemplified by the screenshot in FIG. 8, the device manager and storage modules enable fleet control, device onboarding and provisioning with security; lifecycle control with remote procedure call and Over-the-air updates (FOTA) through REST APIs; data Management for storage, aggregation, and feeding of data to data visualization platform; event management with integrated alarm engine, dedicated data storage service, analytics and dashboarding, and a data file for download (e.g., .csv file).

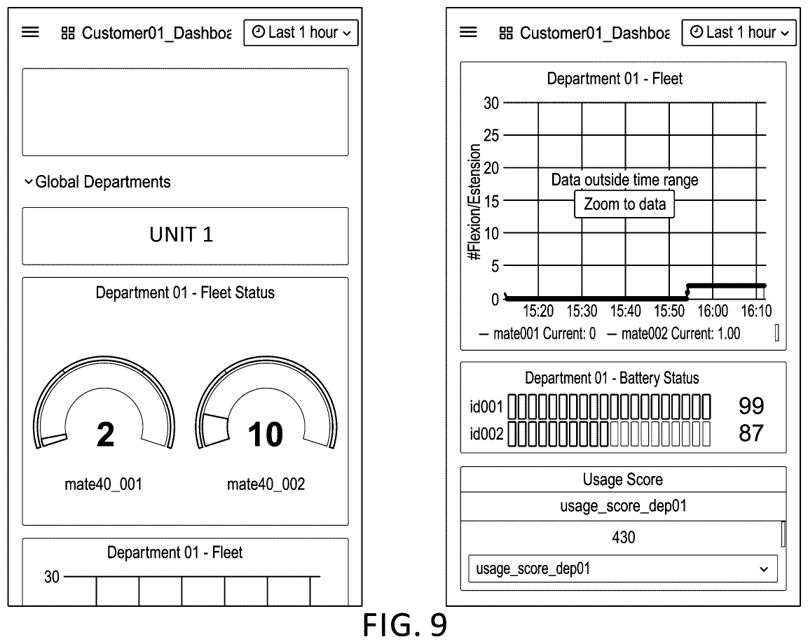

FIG. 9 shows screenshots of the dashboard module that may be based on a Grafana engine provided by Grafana Labs of New York, New York, providing a multi-platform open source analytics and interactive visualization web application. The dashboard module uses machine learning for analytics and interactive data visualization, such as charts, graphs, and alerts according to the data source. Various logins and personalized dashboards for observing the data may be used.

Operators can use cloud-based monitoring and maintenance management tools by providing a system for assisting efforts by a user along with onboard componentry for monitoring performance and maintenance. The onboard componentry can be retrofitted to existing exoskeletons to use commercially available exoskeletons with no or minimal adaptation. Such abilities to monitor the exoskeleton's usage, performance, and maintenance can be extended to a fleet of exoskeletons to observe each exoskeleton individually.

Without prejudice to the invention's principle, the details of construction and the embodiments may vary, even significantly, regarding what has been illustrated purely by way of non-limiting example, without departing from the scope of the disclosure, defined by the annexed claims.

While the disclosure discusses embodiments for the shoulder, embodiments of the disclosure may be used with other limbs, joints, and anatomical portions, including the torso, elbow, wrist/hand, hip, knee, and foot/ankle. Embodiments of the system may be used in other orthopedic, prosthetic, medical, and other devices, and are not limited to the embodiments shown.

Not necessarily all such objects or advantages may be achieved under an embodiment of the disclosure. Those skilled in the art will recognize that the disclosure may be embodied or carried out to achieve or optimize one advantage or group of advantages as taught without achieving other objects or advantages as taught or suggested.

The skilled artisan will recognize the interchangeability of various components from different embodiments described. Besides the variations described, other known equivalents for each feature can be mixed and matched by one of ordinary skill in this art to construct a hinge assembly under the principles of the present disclosure. Therefore, the embodiments described may be adapted to systems for any suitable device, including orthopedic, prosthetic, medical, and other devices.

Although the system for assisting an operator in exerting efforts, the onboard componentry, and associated modules have been disclosed in certain preferred embodiments and examples, it, therefore, will be understood by those skilled in the art that the present disclosure extends beyond the disclosed embodiments to other alternative embodiments and uses of the system and obvious modifications and equivalents. It is intended that the scope of the present system disclosed should not be limited by the disclosed embodiments described above but should be determined only by a fair reading of the claims that follow.

1.-20. (canceled)

21. An exoskeleton, comprising:
a frame;
at least one assistive device supported by the frame;
at least one module associated with the at least one assistive device, the at least one module arranged for monitoring or regulating performance of the exoskeleton, at least one module including a sensor system;
wherein the at least one assistive device comprises a casing substantially surrounding interior components of the at least one module being located within the casing.

22. The exoskeleton of claim 21, wherein the at least one module is fully contained within the casing encasing the at least one assistive device.

23. The exoskeleton of claim 21, wherein the at least one module includes an external interface located along an exterior of the casing, the interface including at least one control or indicator associated with operation of the at least one module.

24. The exoskeleton of claim 21, wherein the at least one module includes an integrated Internet of Thing (IoT) module providing a cloud-based monitoring and maintenance management tool for observing data obtained from the IoT module of the exoskeleton.

25. The exoskeleton of claim 21, wherein the sensor system comprises at least one sensor connected to the at least one assistive device and communicating to the at least one module.

26. The exoskeleton of claim 21, wherein the at least one module is arranged to wirelessly transmit data to a data and device management system.

27. The exoskeleton of claim 26, wherein the data and device management system is located remote from the at least one assistive device.

28. The exoskeleton of claim 21, wherein the at least one module is accessible from a control device exterior of the at least one assistive device.

29. The exoskeleton of claim 28, wherein the control device includes a data port for communicating to the at least one module.

30. The exoskeleton of claim 21, wherein the sensor system is located in the assistive device.

31. A fleet of exoskeletons including at least two exoskeletons, wherein each exoskeleton comprises the features of claim 21, and the at least one module of each of the exoskeletons transmits data to a data and device management system.

32. A method for monitoring at least one exoskeleton, the at least one exoskeleton includes a frame and at least one assistive device supported by the frame, wherein the method comprises:
monitoring or regulating a performance of the exoskeleton with at least one module associated with the at least one assistive device;
providing a sensor system connected to the at least one assistive device and communicating with the at least one module.

33. The method of claim 32, further comprising the step transmitting of data to a data and device management system.

34. The method of claim 32, wherein the at least one exoskeleton comprises a fleet of exoskeletons, each of the exoskeletons of the fleet of exoskeletons individually transmitting data and device management system.

35. The method of claim 32, wherein the at least one assistive device comprises a casing substantially surrounding interior components, at least part of the at least one module being located within the casing.

36. The method of claim 35, wherein the at least one module is fully contained within the casing encasing the at least one assistive device.

37. The method of claim 35, further comprising the step of operating the at least one module by using an interface located along the casing.

38. The method of claim 32, wherein the at least one assistive device includes a torque-generating box in which the sensor system is fully contained without any external wires.

39. The method of claim 32, further comprising the step of outputting on an output device carried by the at least one assistive device an indication including at least one of faults, need for preventive maintenance and notification on usage hints.
